(19) United States
(12) Patent Application Publication
(10) Pub. No.: US 2023/0197114 A1
(43) Pub. Date: Jun. 22, 2023

(54) STORAGE APPARATUS, PLAYBACK APPARATUS, STORAGE METHOD, PLAYBACK METHOD, AND MEDIUM

(71) Applicant: CANON KABUSHIKI KAISHA, Tokyo (JP)

(72) Inventor: TORU SUNEYA, Kanagawa (JP)

(21) Appl. No.: 18/066,808

(22) Filed: Dec. 15, 2022

(30) Foreign Application Priority Data
Dec. 20, 2021 (JP) 2021-206254

(51) Int. Cl. G11B 27/34; G06F 3/16

(52) U.S. Cl. CPC G11B 27/34; G06F 3/165

(57) ABSTRACT

A storage apparatus is provided. The storage apparatus detects a sound pressure of an audio and a repetitive segment in the audio. The storage apparatus generates specifying data for specifying audio data of a specific segment among the repetitive segments being detected. The specific segment is selected in accordance with a sound pressure. The storage apparatus stores the specifying data together with audio data of the audio in one file in a predetermined format.

### BACKGROUND

### Field of the Disclosure

The present disclosure relates to a storage apparatus, a playback apparatus, a storage method, a playback method, and a medium, in particular to a storage and a playback method of an audio file.

### Description of the Related Art

In recent years, the number of users who use online music distribution services has been increasing. For example, in an outright purchase type service, data can be purchased for each music, and the purchased music can be played at any time. In a subscription type service, a right to play a variety of music only in a contract period can be obtained. Further, the user may download audio data from the music distribution service to a local terminal, and in this case, music can be played in an offline environment.

In order to facilitate the search for music that will be a user's favorite when purchasing the audio data, it is desirable to be able to try listening to a characteristic part of the music. For example, when the user listens to a part of the music on a television CM or the like, the user may like this music and search for this music. In this case, even when the user does not know the music title, the user can efficiently find the music of interest if the user can mainly listen to the characteristic part of a candidate music when the user tries listening to the candidate music.

On the other hand, a technique for dividing music into a plurality of segments is also known. For example, Japanese Patent Laid-Open No. 2014-109659 discloses a technique for dividing contents of a singing movie into a plurality of segments and combining the respective segments of a plurality of singing movies. Examples of the segments include climax/High Point, A section/Verse, and B section/Bridge.

### SUMMARY

According to an embodiment of the present disclosure, a storage apparatus comprises one or more processors and one or more memories storing one or more programs which cause the one or more processors to: detect a sound pressure of an audio and a repetitive segment in the audio; generate specifying data for specifying audio data of a specific segment among the repetitive segments being detected, wherein the specific segment is selected in accordance with a sound pressure; and store the specifying data together with audio data of the audio in one file in a predetermined format.

According to another embodiment of the present disclosure, a storage apparatus comprises one or more processors and one or more memories storing one or more programs which cause the one or more processors to: obtain specifying data related to a specific segment, wherein the specifying data includes position information and characteristic information, wherein the position information indicates a position of the specific segment that is a part of audio, and wherein the characteristic information represents characteristic of the specific segment; and store the specifying data together with the audio data of the audio in one file in a predetermined format.

According to still another embodiment of the present disclosure, a playback apparatus comprises one or more processors and one or more memories storing one or more programs which cause the one or more processors to: obtain an audio file including audio data of audio and metadata related to a specific segment that is a part of the audio; specify audio data of the specific segment by analyzing the metadata; and read out the audio data of the specific segment, being specified, from the audio file for playback.

According to yet another embodiment of the present disclosure, a non-transitory computer-readable medium comprises: a data structure in which audio data of audio and specifying data related to a specific segment are stored in a predetermined format, wherein the specifying data includes position information and characteristic information, wherein the position information indicates a position of the specific segment that is a part of the audio, and wherein the characteristic information represents characteristic of the specific segment, wherein the specifying data is used by a playback apparatus in a process of reading out audio data of the specific segment from the audio data of the audio stored in a storage, for playing back the specific segment.

According to still yet another embodiment of the present disclosure, a storage method comprises: detecting a sound pressure of an audio and a repetitive segment in the audio; generating specifying data for specifying audio data of a specific segment among the repetitive segments being detected, wherein the specific segment is selected in accordance with a sound pressure; and storing the specifying data together with audio data of the audio in one file in a predetermined format.

According to yet still another embodiment of the present disclosure, a storage method comprises: obtaining specifying data related to a specific segment, wherein the specifying data includes position information and characteristic information, wherein the position information indicates a position of the specific segment that is a part of audio, and wherein the characteristic information represents characteristic of the specific segment; and storing the specifying data together with the audio data of the audio in one file in a predetermined format.

According to still yet another embodiment of the present disclosure, a playback method comprises: obtaining an audio file including audio data of audio and metadata related to a specific segment that is a part of the audio; specifying audio data of the specific segment by analyzing the metadata; and reading out the audio data of the specific segment, being specified, from the audio file for playback.

According to yet still another embodiment of the present disclosure, a non-transitory computer-readable medium stores one or more programs which, when executed by a computer comprising one or more processors and one or more memories, cause the computer to: detect a sound pressure of an audio and a repetitive segment in the audio; generate specifying data for specifying audio data of a specific segment among the repetitive segments being detected, wherein the specific segment is selected in accordance with a sound pressure; and store the specifying data together with audio data of the audio in one file in a predetermined format.

Further features of the present disclosure will become apparent from the following description of exemplary embodiments (with reference to the attached drawings).

### BRIEF DESCRIPTION OF THE DRAWINGS

FIG. 1 is a system diagram according to one or more aspect of the present disclosure.

FIG. 2 is a block diagram illustrating an example of a functional configuration of a processing apparatus according to one or more aspect of the present disclosure.

FIG. 3 is a flowchart illustrating an example of audio data analysis according to one or more aspect of the present disclosure.

FIGS. 4A to 4D are explanatory diagrams illustrating examples of analyzed data according to one or more aspect of the present disclosure.

FIG. 5 is an explanatory diagram illustrating a structure of an audio file according to one or more aspect of the present disclosure.

FIG. 6 is an explanatory diagram illustrating contents of a specifying data according to one or more aspect of the present disclosure.

FIG. 7 is an explanatory diagram illustrating a structure of an audio file according to one or more aspect of the present disclosure.

FIG. 8 is an explanatory diagram illustrating contents of a specifying data according to one or more aspect of the present disclosure.

FIG. 9 is a flowchart illustrating a generation procedure of an audio file according to one or more aspect of the present disclosure.

FIG. 10 is an explanatory diagram illustrating a structure of an audio file according to one or more aspect of the present disclosure.

FIG. 11 is an explanatory diagram illustrating contents of a specifying data according to one or more aspect of the present disclosure.

FIG. 12 is a block diagram illustrating a basic configuration of a computer according to one or more aspect of the present disclosure.

FIG. 13 is a flowchart illustrating a playback procedure of an audio file according to one or more aspect of the present disclosure.

FIG. 14 is an explanatory diagram illustrating a playback menu of an audio file according to one or more aspect of the present disclosure.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### First Embodiment

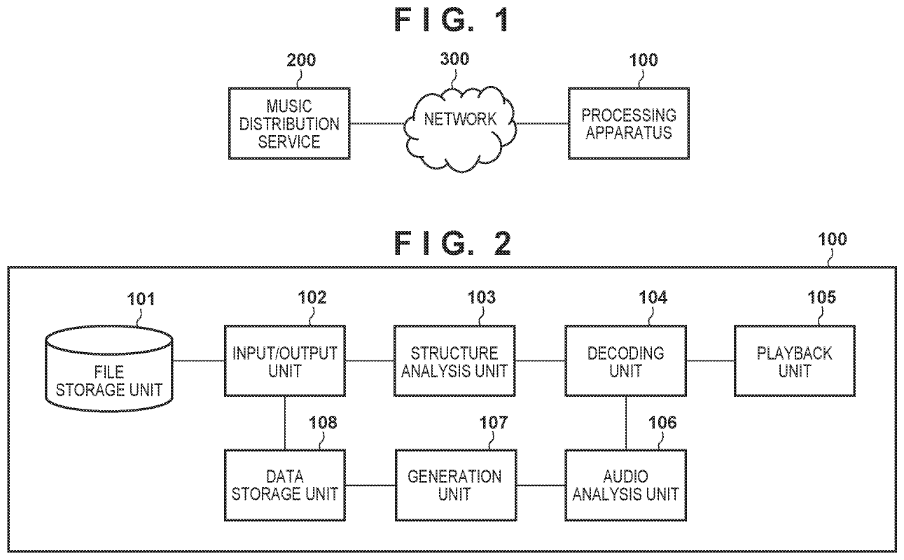

FIG. 1 illustrates an example of a system including a storage apparatus according to an embodiment of the present disclosure. A processing apparatus 100 that is the storage apparatus according to the present embodiment can be connected to a music distribution service 200 via a network 300. Note that a plurality of the processing apparatuses 100 and a plurality of the music distribution services 200 may be present.

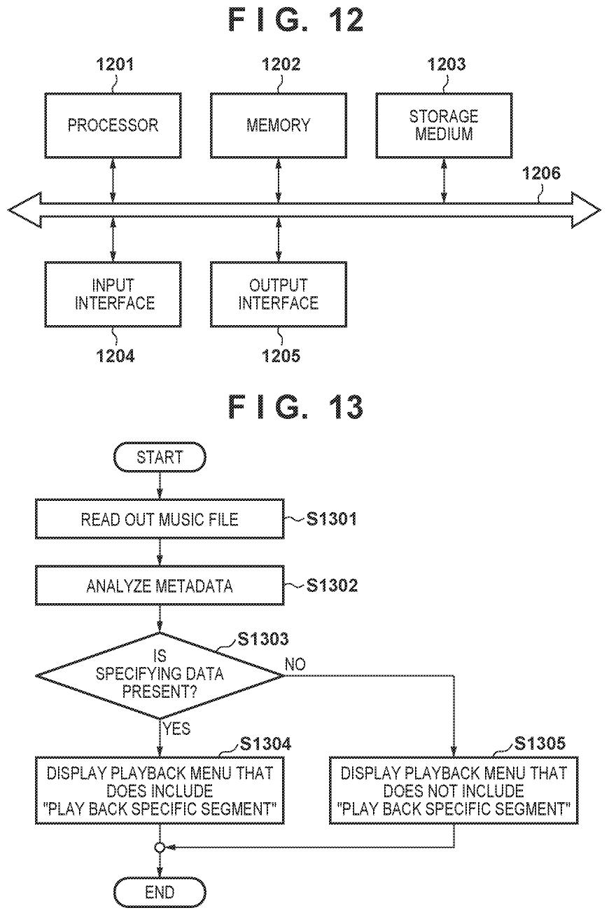

The processing apparatus 100 may be, for example, a personal computer, a smart phone, or a tablet PC, but is not limited to these examples. FIG. 12 is a diagram illustrating a basic configuration of a computer that is usable as the processing apparatus 100. In FIG. 12, a processor 1201 is, for example, a CPU and controls operations of the entirety of the computer. A memory 1202 is, for example, a RAM, and temporarily stores programs, data, and the like. A computer readable storage medium 1203 is, for example, a hard disk, a CD-ROM and the like, and stores programs, data, and the like on a long time basis. In the present embodiment, a program for realizing functions of each unit, which is stored in the storage medium 1203, is read out to the memory 1202. The processor 1201 operates according to the program on the memory 1202, and thus the functions of each unit are realized.

In FIG. 12, an input interface 1204 is an interface for obtaining information from an external apparatus. An output interface 1205 is an interface for outputting information to an external apparatus. A bus 1206 may connect above-described units to each other and enables data exchange. Note that a part or all of each processing unit included in the processing apparatus 100 may be realized by dedicated hardware.

The network 300 may be, for example, a Wide Area Network (WAN) such as the Internet, 3G/4G/LTE/5G, and the like, a wired Local Area Network (LAN), a radio LAN (Wireless LAN), an ad hoc network, or Bluetooth, but is not limited to these examples.

Subsequently, a functional configuration of the processing apparatus 100 according to the present embodiment will be described, referring to FIG. 2. The processing apparatus 100 according to the present embodiment includes a generation unit 107 and a data storage unit 108. As illustrated in FIG. 2, the processing apparatus 100 may further include a file storage unit 101, an input/output unit 102, a structure analysis unit 103, a decoding unit 104, a playback unit 105, and an audio analysis unit 106.

The file storage unit 101 can store an audio file. The file storage unit 101 may store, as the audio file, a music file downloaded from a music distribution service.

The input/output unit 102 can read out the audio file stored in the file storage unit 101, and write the audio file to the file storage unit 101.

The structure analysis unit 103 can analyze a format of the audio file read out from the file storage unit 101 via the input/output unit 102, and extract encoded data of audio stored in the audio file. The decoding unit 104 can decode the encoded data extracted by the structure analysis unit 103. The playback unit 105 can output the audio data, obtained by decoding by the decoding unit 104, from an output unit such as a speaker.

The audio analysis unit 106 sets a specific segment that is a part of the audio. This specific segment may correspond to a characteristic part of the audio. For example, in a case where the audio is music, the specific segment may be a part including a representative phrase, a lively part, or a High Point part, of the music.

The audio analysis unit 106 according to the present embodiment can detect a sound pressure of the audio and a repetitive segment in the audio. For example, the audio analysis unit 106 has a function of quantitatively analyzing the audio data obtained by decoding by the decoding unit 104. Specifically, the audio analysis unit 106 may have a function of frequency analysis, sound pressure analysis, and pattern analysis for detecting a repetitive pattern of the music. In this way, the audio analysis unit 106 can set the specific segment by analyzing at least one of the sound pressure of the audio, the repetitive segment, and the frequency.

An example of a setting method of the specific segment by the audio analysis unit 106 will be described later. On the other hand, the specific segment may be set by the user instead of the audio analysis unit 106. For example, depending on the audio, it may be difficult to detect the characteristic part by the analysis. In such a case, the user who actually listens to the audio can set, as the specific segment, a desired segment.

The generation unit 107 can obtain data related to the specific segment that is a part of the audio. In the present embodiment, the generation unit 107 generates data related to the specific segment selected in response to a sound pressure among the repetitive segments detected by the audio analysis unit 106. In this example, the data related to this specific segment (hereinafter also referred to as specifying data) is data specifying the audio data of the specific segment. For example, the specifying data may be position information indicating a position of the specific segment in the audio. By using such position information, the specific segment in the audio can be identified.

On the other hand, the specifying data may include characteristic information representing characteristic of the specific segment. For example, the specifying data may include sound pressure information of the specific segment. Further, the specifying data may include information representing a type of the specific segment. For example, the specifying data may include information indicating that the specific segment is a characteristic part (for example, a High Point that is a part including a representative phrase) of the audio. Another example of the type of the specific segment includes a Verse, a Bridge, a first movement, and the like. By using such characteristic information, it becomes easier for the user to grasp the characteristic of the specific segment or the characteristic part of the audio, and to select the audio to be played from among a plurality of pieces of the audio. The specifying data may include the position information indicating the position of the specific segment, may include the characteristic information representing the characteristic of the specific segment, and may include both of them.

In the present embodiment, the generation unit 107 generates the specifying data as described above according to an analysis result by the audio analysis unit 106. On the other hand, the generation unit 107 may generate the specifying data according to the setting of the specific segment by the user, or may obtain the specifying data based on the user input.

The data storage unit 108 stores the data related to the specific segment into one file in a predetermined format, together with the audio data of the audio. The data storage unit 108 can store, into an analyzed audio file, the specifying data generated by the generation unit 107. The audio file that stores the specifying data is written to the file storage unit 101 by the input/output unit 102.

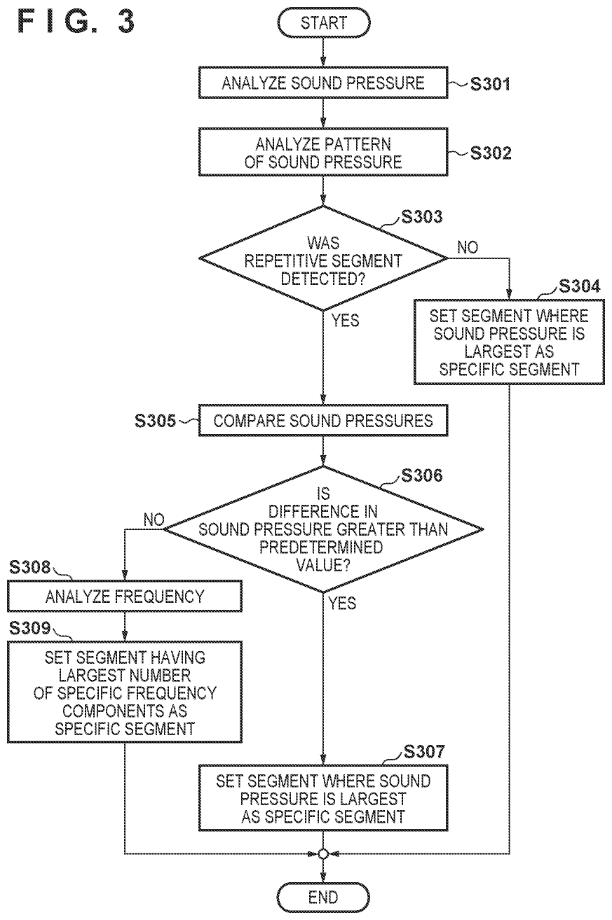

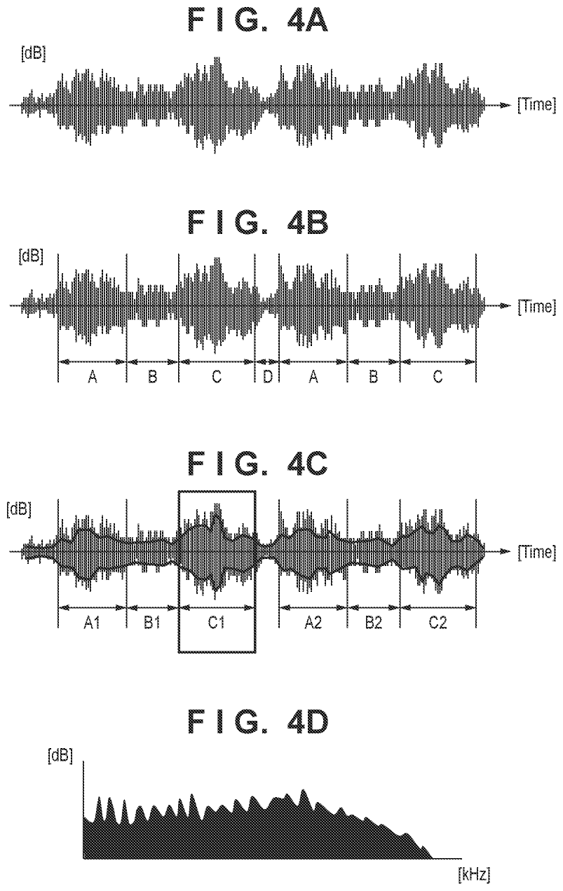

Next, an example of processing performed by the audio analysis unit 106 will be described with reference to FIGS. 3 and 4A to 4D. In the following processing, the audio analysis unit 106 sets the specific segment based on the sound pressure of the audio and the repetitive segment in the audio. On the other hand, the setting method of the specific segment is not limited to the following method, and for example, the audio analysis unit 106 may set, as the specific segment, the characteristic part of the audio detected using a neural network.

In S301, the audio analysis unit 106 detects the sound pressure of the audio. For example, as illustrated in FIG. 4A, the audio analysis unit 106 can detect the sound pressure from the start to the end of the audio data. Note that FIGS. 4A to 4C illustrate examples of analysis results of stereo audio.

In the following S302, the audio analysis unit 106 analyzes a pattern of the sound pressure based on the detection results of the sound pressure. In this analysis, the audio analysis unit 106 can detect a segment in which a waveform pattern having a similar sound pressure is locally repeated. For example, FIG. 4B illustrates an example in which four patterns of A, B, C, and D are detected.

In the following S303, the audio analysis unit 106 detects a repetitive segment in the audio. The audio analysis unit 106 can detect the repetitive segment based on the analysis results of the pattern of the sound pressure. For example, the audio analysis unit 106 can determine whether the waveform pattern having the similar sound pressure is repeated two or more times with a different waveform pattern interposed therebetween. If no repetitive segment is detected, then the processing proceeds to S304. In S304, the audio analysis unit 106 sets, as the specific segment, a segment where the sound pressure is the largest among the segments detected in S302.

On the other hand, if the repetitive segment is detected in S303, then the processing proceeds to S305. In S305, the audio analysis unit 106 compares the sound pressures for each repetitive segment. Then, in the subsequent S306, the audio analysis unit 106 determines whether a difference in the sound pressure between the repetitive segment of the maximum sound pressure and the repetitive segment of next higher sound pressure is greater than a predetermined value. If the difference in the sound pressure is greater than the predetermined value, then the processing proceeds to S307, and the audio analysis unit 106 sets one of the repetitive segments, at which the sound pressure is greatest, as the specific segment. For example, FIG. 4C illustrates a state in which the sound pressure of the segments of the repetitive pattern C is greatest among the detected three repetitive patterns A, B, and C, and the difference in the sound pressure between the segments of the repetitive pattern C and the segments of the repetitive pattern A with next higher sound pressure is greater than the predetermined value. In this example, a segment of C1, which is a segment of the greatest sound pressure among the segments of the repetitive pattern C is set as the specific segment.

On the other hand, if the difference in the sound pressure is a predetermined value or less, then the processing proceeds to S308, and the audio analysis unit 106 performs the frequency analysis of the audio. For example, the audio analysis unit 106 can analyze the frequency of the entirety of the audio as illustrated in FIG. 4D. In the following S309, the audio analysis unit 106 can set, as the specific segment, a segment having the largest number of specific frequency components. Here, specific frequency components can be selected depending on the type of the audio. For example, the specific frequency components may be a frequency band mainly including a human voice or may be a frequency band mainly including a sound of a specific musical instrument.

The specific segment set as illustrated in FIGS. 3 and 4A to 4D are likely to be a segment including a characteristic part in a modern general musical piece, for example, a representative phrase of a musical piece. Note that when comparing the sound pressure of each segment, an average value of a magnitude of the sound pressure of each segment may be compared, or the maximum value of the magnitude of the sound pressure of each segment may be compared. Furthermore, both the average value and the maximum value may be used to compare the sound pressure of each segment.

The length of the specific segment may be limited. For example, the length of the specific segment may be limited to a predetermined length or less, or may be limited to a predetermined length or greater. In this case, in S302, the pattern analysis may be performed in consideration of such a limit. For example, the audio analysis unit 106 can detect the segment so that the length of each segment satisfies the limit. As another method, a segment that is a part of the specific segment set according to the flowchart in FIG. 3 or a segment including the part may be set as a final specific segment. For example, the audio analysis unit 106 can set, as the final specific segment, a segment that starts from a head of the specific segment set according to the flowchart of FIG. 3, and having a length satisfying the limit. In this case, the specific segment may include a plurality of the segments detected in S302, that is, the specifying data may be information to specify a segment that includes the specific segment in at least part of the segment.

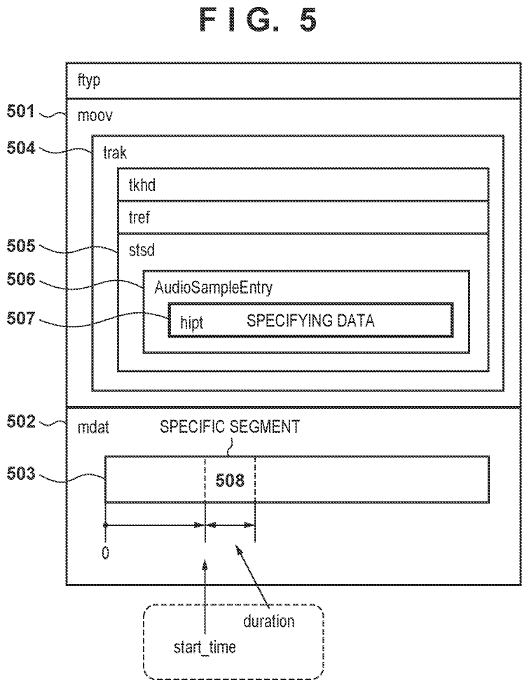

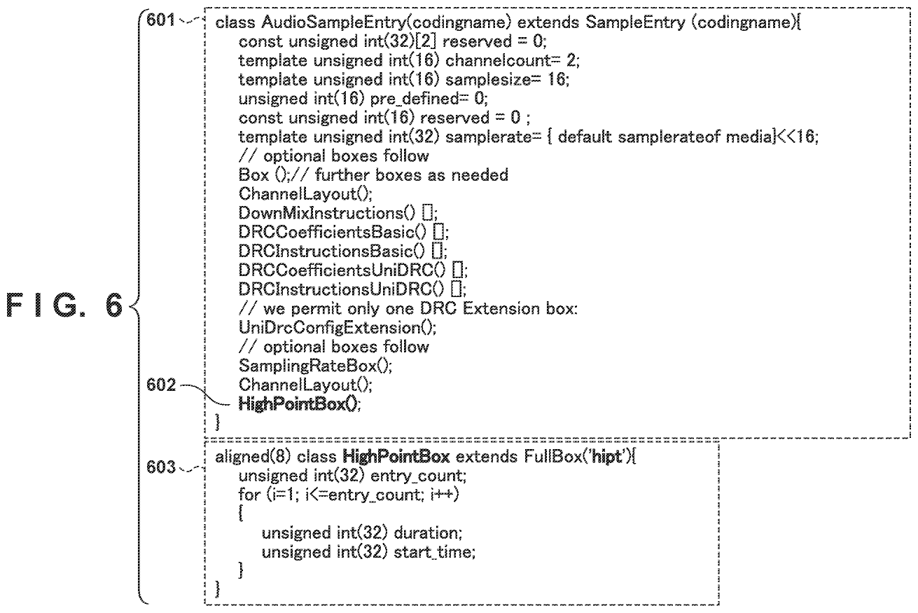

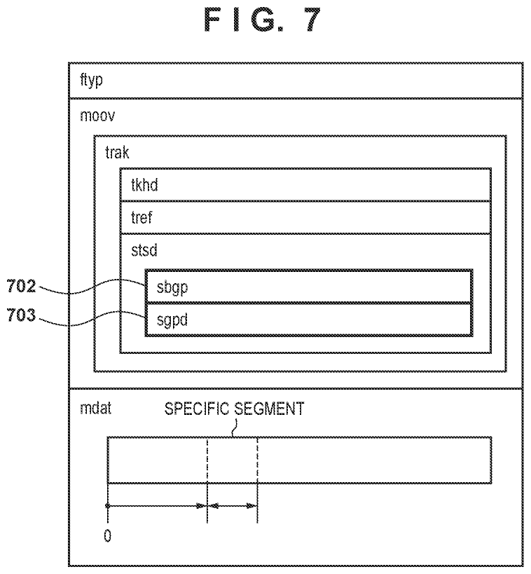

Next, a method of storing the specifying data related to the specific segment into the audio file will be described with reference to FIGS. 5 and 6. FIG. 5 illustrates a structure of an audio file according to an MP4 file format, according to an embodiment. The MP4 file format has a tree structure in which elements called BOX are nested, and only main BOXes are illustrated in FIG. 5. In FIG. 5, four lowercase alphabetical letters represent the name of the BOX. In this example, time information indicating the position of the specific segment is stored into the audio file, as the specifying data.

Encoded audio data 503 are stored in mdat (502), and metadata are stored in moov (501). For example, data required for playback processing of the audio data can be stored as the metadata. The MP4 file format has a structure called a track corresponding to each medium such as the audio or the movie to be stored, and trak (504) is a BOX that stores information of the track.

The trak (504) comprises a plurality of the BOXes. stsd (505) is called SampleDescriptionBox, and detailed information such as information necessary to decode the audio data (503) and timing information when performing playback processing is stored. In the track of the audio data, the stsd (505) has a structure called AudioSampleEntry (506). The AudioSampleEntry (506) stores information such as sampling frequency of the audio data, number of bits, and number of channels.

In one embodiment of the present disclosure, the specifying data is stored in the AudioSampleEntry (506). In the example of FIG. 5, the specific segment 508 is the High Point of the audio, and the specifying data is position information indicating the position of the specific segment 508, and is described as hipt (507).

Next, the contents of the specifying data to be stored into the AudioSampleEntry (506) will be described with reference to FIG. 6. In FIG. 6, a code 601 illustrates a syntax of the AudioSampleEntry (506). The basic configuration is the same as that of the standard specifications for the MP4 file format, but HighPointBox (602) is added in the last line, differently from the standard specifications.

A code 603 in FIG. 6 is an example of a syntax of the HighPointBox (602). As the position information indicating the position of the specific segment for the audio data 503 in FIG. 5, start_time indicating a time at which the specific segment starts and duration indicating a period of the specific segment are stored. Note that the specific segment may be divided into a plurality of segments. For example, in the example of FIG. 4C, both the segment of C1 and the segment of C2 may be selected as the specific segments. In this case, entry_count in the syntax of the HighPointBox (602) may be two or more. Note that numerical values based on a time scale set for each track can be set to the start_time and the duration. For example, in a case where the sampling frequency of the audio data is 48 kHz and the time scale of the track is 48000, a period per sample is 1024. Thus, in a case where the specific segment is 30 seconds from the time point of 1 minute and 25 seconds, the start_time=4079616 (1024×3984), and the duration=1439744 (1024×1406) are set.

In this way, the specifying data can be stored into SampleEntry of the audio file. In FIGS. 5 and 6, the name of the BOX that stores the specifying data is the HightPointBox and its four-letter code is hipt, but these are only examples and another name and a four-letter code may be used. For example, as a combination of the name of the BOX and the four-letter code, FeaturePartBox (feat), ImpressionPartBox (impr), HighlightBox (hglt), or ChorusBox (chrs) may be used.

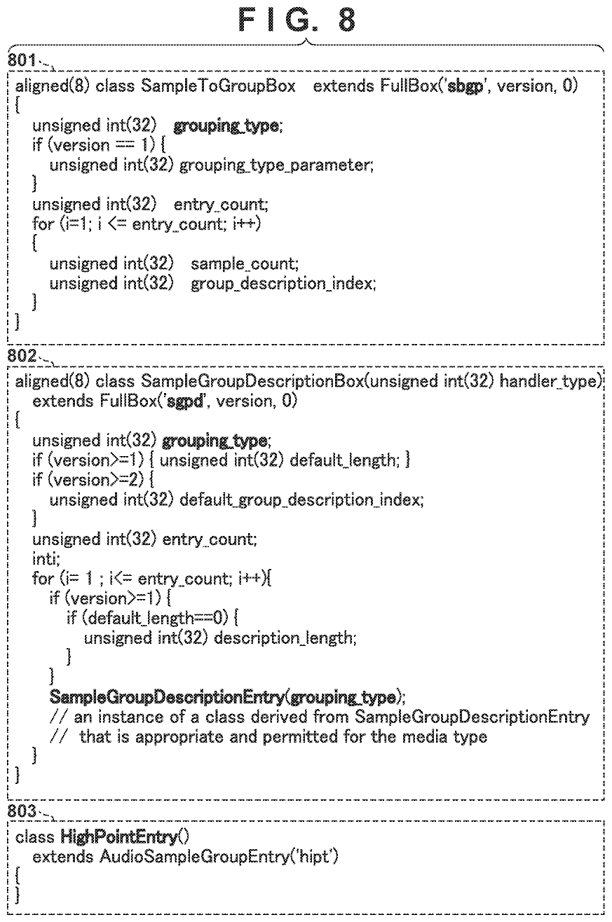

Next, another method of storing the specifying data related to the specific segment into the audio file will be described with reference to FIGS. 7 and 8. FIG. 7 also illustrates a structure of the audio file according to the MP4 file format according to an embodiment. In this example, sample count information that is position information indicating the position of the specific segment, is stored into the audio file, as the specifying data.

In FIG. 7, sbgp (702) is a sample to group box, sgpd (703) is a sample group description box, and both are defined by the standard specifications for the MP4 file format. The sbgp (702) can define a group constituted by a set of samples having some common attributes. The sgpd (703) can define these common attributes as a grouping type and store attribute information for the group. In this example, samples corresponding to the specific segment are grouped using the sbgp (702), and the attribute information of the specific segment is defined using the sgpd (703).

These determination methods will be described with reference to FIG. 8. In FIG. 8, a code 801 illustrates a syntax of the sbgp (702). Here, grouping is performed by setting the group_description_index for each sample_count. The fact that the group_description_index is “0” indicates that the sample is not grouped. Thus, the group_description_index of a sample before the specific segment can be set to “0”, and the group_description_index of a sample in the specific segment can be set to a numerical value of one or more. By such a method, samples corresponding to the specific segment can be grouped. In this way, the specifying data can be stored as sample group information of the audio file.

A code 802 illustrates a syntax of the sgpd (703) and defines attribute information of the group defined according to the code 801. Here, information related to the specific segment can be defined as SampleGroupDescriptionEntry. Examples of a definition of the SampleGroupDescriptionEntry include a BOX illustrated in a code 803 in FIG. 8. HighPointEntry illustrated in the code 803 does not have any particular parameter. However, the HighPointEntry may store the characteristic information representing the characteristic of the specific segment. For example, the HighPointEntry can store a parameter indicating the sound pressure of the specific segment. By such a configuration, the sound pressure information of the specific segment, which is the characteristic part of the music and the lively part can be stored.

As described above, the position of the specific segment can be specified using the time or the sample group. However, the method of identifying the specific segment of the audio is not limited to the example described here.

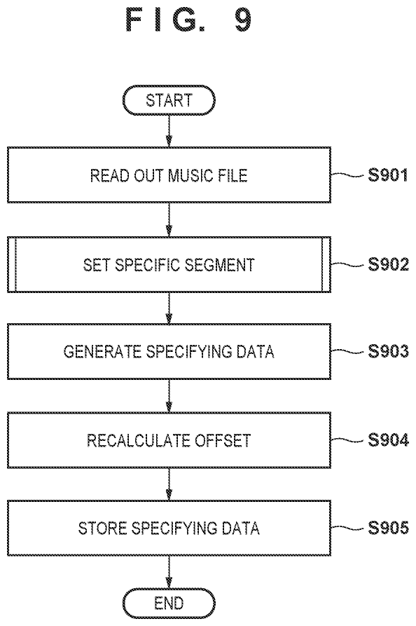

Next, a procedure of storing a file including the data related to the specific segment will be described with reference to FIG. 9. A procedure for generating the MP4 file as illustrated in FIG. 5 or 7 will be described below.

First, in S901, the generation unit 107 reads out the audio file from the file storage unit 101. In S902, the audio analysis unit 106 sets the specific segment. As described above, the audio analysis unit 106 may set the specific segment according to the flowchart in FIG. 3, or may set the specific segment based on the user input.

In S903, the generation unit 107 generates the specifying data that is data related to the specific segment. As described above, the specifying data may be the position information indicating the position of the specific segment, and/or the characteristic information representing the characteristic of the specific segment. As a specific example, the generation unit 107 can generate the specifying data according to the method described with reference to FIG. 5 or FIG. 7.

When the specifying data generated in S903 is stored into the audio file as the metadata, there is a possibility that a position of the mdat (502) in the file changes due to a change in the number of bytes of the moov (501) that is the BOX that stores the metadata. Thus, in the following S904, when the number of bytes from the head of the file to the head of the mdat (502) changes, the generation unit 107 changes an offset value for referring to the encoded audio data. In this way, the generation unit 107 recalculates the offset value.

Note that there are many types of the BOX that utilize the offset value. In order to reduce recalculation with complex processing, a BOX such as a free BOX whose content is often not read can be arranged in advance in the moov (501) or between the moov (501) and the mdat (502). In this case, the generation unit 107 can prevent the position of the mdat (502) in the file from being changed by reducing the free BOX by increase amount of the metadata.

In the following S905, the data storage unit 108 stores, into the audio file, the specifying data generated in S903, as the metadata. That is, the data storage unit 108 can update the metadata of the audio file read out in S901 to include the specifying data generated in S903. At this time, the data storage unit 108 can update the offset value in the metadata of the audio file according to the result in S904.

The case has been described above in which the position information indicating the position of the specific segment or the characteristic information indicating the characteristic of the specific segment is stored into the file, as the data related to the specific segment. On the other hand, the types of the data related to the specific segment are not limited thereto. In the following, a case will be described in which information specifying the audio data of the specific segment stored separately from the audio data is stored into the file, as the data related to the specific segment.

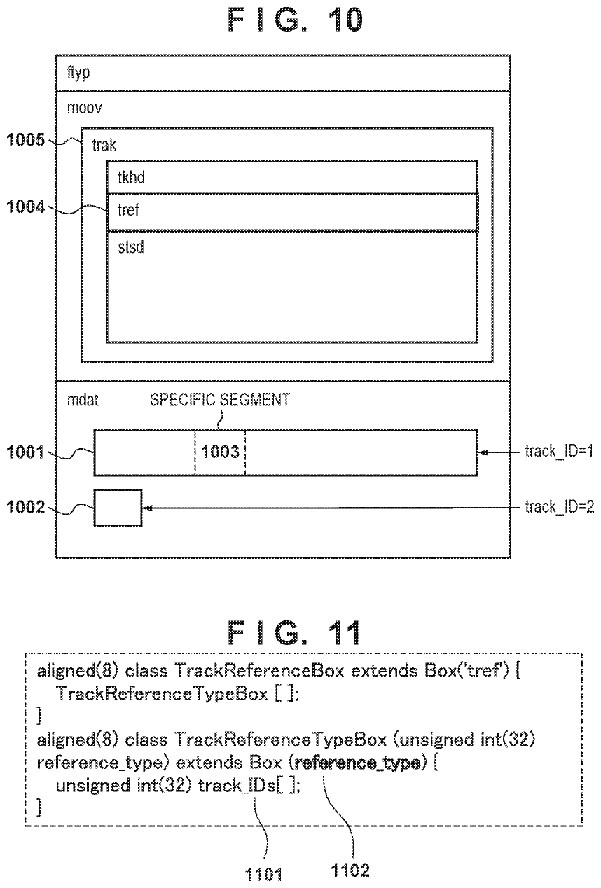

In the present embodiment, the data storage unit 108 stores, into one audio file, the audio data of the specific segment, separately from the audio data. For example, the data storage unit 108 can store the audio data of the specific segment into a track separate from the audio data. FIG. 10 illustrates a structure of an audio file according to the MP4 file format, according to an embodiment. The mdat stores audio data 1001 and audio data 1002. An ID of a track for managing the audio data 1001 is 1, and an ID of a track for managing the audio data 1002 is 2. The audio data 1002 includes the same contents as the specific segment of the audio data 1001. That is, the audio of the audio data 1002 is a part of the audio of the audio data 1001.

On the other hand, a format of the audio data may be different between the audio data 1001 and the audio data 1002. For example, an audio data attribute such as a sampling rate, a quantization bit number, or a coding format may be different between the audio data 1001 and the audio data 1002. Thus, the data storage unit 108 can store the audio data of the specific segment, in a format different from that of the audio data.

As an example, the audio data 1001 may have the coding format MPEG-4 Audio Lossless Coding (ALS), the sampling rate of 192 kHz, and the quantization bit number of 24 bit. On the other hand, the audio data 1002 may have the coding format of a linear PCM, the sampling rate of 48 kHz, and the quantization bit number of 16 bit. In this case, the audio data 1001 is a high quality audio data referred to as a so-called high-resolution and may not be played back in a case where playback equipment with low capability is used. On the other hand, the audio data 1002 may be played back by most playback equipment. By preparing such an audio file, music can be efficiently grasped by playing back the audio data 1002 that is the characteristic part of the music when listening to the music is tried. In addition, since the quality of the audio data 1001 and the audio data 1002 is different from each other, the music can be played back by a variety of playback equipment, or can be played back with a lower processing load.

When a plurality of the tracks are present as in the present embodiment, the number of trak (1005) present is the same as the number of tracks. Information indicating that the audio data 1002 includes the same contents as the specific segment 1003 of the audio data 1001 can be stored into tref (1004). The tref (1004) is a BOX that stores reference information between tracks, and can have the configuration illustrated in FIG. 11.

In FIG. 11, trak_IDs (1101) describes an ID of a track of a reference destination in an array format. A reference_type (1102) describes an identifier of a four-letter code indicating a type of reference relationship. In the present embodiment, the audio data 1002 of the track ID=2 has the same contents as the specific segment 1003 of the audio data 1001 of the track ID=1. Thus, trak_IDs (1101) in the tref (1004) of the track ID=2 can be 1. Reference_type (1102) in the tref (1004) of the track ID=2 can be hipt (HighPointBox), feat (FeaturePartBox), impr (ImpressionPartBox), hglt (HighlightBox), or chrs (ChorusBox). or the like.

Such reference information is data related to a specific segment for audio data of a specific track (for example, audio data 1001), and can be used to identify the audio data of the specific segment (for example, audio data 1002). The reference_type (1102) is also data related to the specific segment, and can also indicate the type (for example, High Point) of the specific segment. In this embodiment, these data can be stored into the audio file, as the data related to the specific segment. Thus, the data storage unit 108 can store, into a track different from that of the audio data, the audio data of the specific segment, and can store the data related to the specific segment, as the track reference information. Note that, for example, data such as the position information described above, indicating that the specific segment is corresponding to which segment of the audio stored as the audio data 1001, may be further stored as the data related to the specific segment.

The generation of such an MP4 file can also be performed according to the flowchart in FIG. 9. The generation of the specifying data in S903 can be performed as follows. The generation unit 107 re-encodes the audio data of the specific segment set in S902. At this time, the generation unit 107 may change the audio data attribute such as the sampling rate, the quantization bit number, or the coding format, from the original attribute. The data storage unit 108 stores, into the mdat, the audio data obtained by the re-encoding. The generation unit 107 generates a new track for managing this audio data, and includes the specifying data in this track. This data is stored into the audio file, as the metadata in S905.

As described above, according to the present embodiment, information which can specify the audio data of the specific segment that is the part of the audio can be stored into the audio file. By using such an audio file, the audio of the specific segment such as the part including the representative phrase can be preferentially played back.

### Second Embodiment

Next, a method of playing back the audio file that can be created according to the above-described embodiment will be described. The processing apparatus 100 can be used as a playback apparatus that plays back the audio file. The input/output unit 102 obtains an audio file including the audio data of the audio and the metadata related to the specific segment that is a part of the audio.

The structure analysis unit 103 identifies the audio data of the specific segment by analyzing the metadata. For example, in a case where the audio file illustrated in FIG. 5 is obtained, the structure analysis unit 103 can specify the audio data of the specific segment 508 according to the hipt (507) that is the specifying data. In a case where the audio file illustrated in FIG. 7 is obtained, the structure analysis unit 103 can specify the audio data of the specific segment that are grouped according to the sbgp (702) and the sgpd (703) that are the specifying data. In a case where the audio file illustrated in FIG. 10 is obtained, the structure analysis unit 103 can specify the audio data 1002 of the specific segment with respect to the audio data 1001 according to the tref (1004) that is the specifying data.

The decoding unit 104 can read out the audio data of the specific segment specified by the structure analysis unit 103 from the audio file for playback. In the present embodiment, the decoding unit 104 can decode the encoded audio data, and can transmit the audio data to the playback unit 105 for playback.

Next, such a method of playing back the audio file will be described with reference to FIG. 13. In S1301, the input/output unit 102 reads out the audio file from the file storage unit 101. As described above, the specifying data related to the specific segment is stored in the audio file, as the metadata. Thus, in S1302, the structure analysis unit 103 performs analysis of the metadata of the audio file read out.

The structure analysis unit 103 can control whether to display, an item relating to playback of the audio of the specific segment, to a user interface in accordance with whether the audio file includes the metadata related to the specific segment. That is, the user interface can be changed in accordance with whether the specifying data is present. For example, in the following S1303, the structure analysis unit 103 can determine whether the specifying data is present in the audio file. If the specifying data is present, then the process proceeds to S1304. In S1304, the structure analysis unit 103 can display, on a display (not illustrated), a playback menu that includes a “play back a specific segment” item. If no specifying data is present in S1303, then the processing proceeds to S1305. In S1305, the structure analysis unit 103 can display, on the display (not illustrated), a playback menu that does not include the “play back a specific segment” item. Thereafter, based on the user operation for these user interfaces, the playback unit 105 can perform playback of the specific segment among the audio, or perform playback of the entirety of the audio.

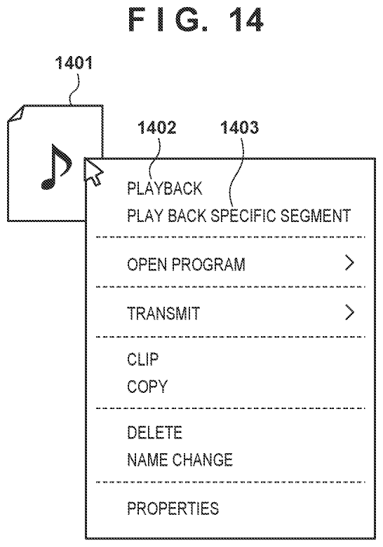

Next, an example of the playback menu will be described, referring to FIG. 14. FIG. 14 illustrates an example of a context menu that is a user interface displayed when the audio file 1401 is played back. “Playback” 1402 that instructs to play back the audio data from the beginning is always displayed while “play back a specific segment” 1403 that plays back only the specific segment is displayed only when the audio file 1401 includes the specifying data. That is, when the audio file 1401 includes the specifying data, only the specific segment can be played back by selecting the “play back a specific segment” 1403.

A playback control method using the specifying data is not limited to the method illustrated in FIG. 13. For example, in a case where the user desires to find a desired music from among a plurality of pieces of music, only a specific segment of each of the plurality of music may be continuously played back. In this case, during the continuous playback, information that indicates a specific segment of which music is currently played back may be displayed on the user interface or may be notified by an audio guide.

One audio file according to the MP4 file format can store a plurality of pieces of music data. For example, an album of favorite artists or a set of favorite music may be stored into the one audio file. Each of the music data stored in this way can be stored as separate tracks. Thus, by storing the specifying data for each track into the audio file, it becomes easy to select the music data desired to listen to.

In the above, the case has been described in which the processing apparatus 100 illustrated in FIG. 1 operates as the storage apparatus or the playback apparatus. However, the storage apparatus and the playback apparatus according to the embodiment may be implemented by other apparatuses. The storage apparatus and the playback apparatus according to the embodiment may be configured by a plurality of information processing apparatuses connected via a network, for example.

An embodiment of the present disclosure also relates to the data structure for the audio file as described above. The data structure according to the embodiment is a data structure in which the audio data of the audio and the specifying data related to the specific segment that is a part of the audio are stored in a predetermined format. The specifying data may specify the audio data of the specific segment, or may include the position information indicating the position of the specific segment that is a part of the audio and the characteristic information indicating the characteristic of the specific segment. The data related to the specific segment is used in a process in which the structure analysis unit 103 of the playback apparatus reads out the audio data of the specific segment from the audio data of the audio stored in the file storage unit 101 in order to play back the specific segment.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-206254, filed Dec. 20, 2021, which is hereby incorporated by reference herein in its entirety.

What is claimed is:

1. A storage apparatus comprising one or more processors and one or more memories storing one or more programs which cause the one or more processors to:
detect a sound pressure of an audio and a repetitive segment in the audio;
generate specifying data for specifying audio data of a specific segment among the repetitive segments being detected, wherein the specific segment is selected in accordance with a sound pressure; and
store the specifying data together with audio data of the audio in one file in a predetermined format.

2. The storage apparatus according to claim 1, wherein the specifying data is position information indicating a position of the specific segment in the audio.

3. The storage apparatus according to claim 1, wherein the specifying data is time information indicating a position of the specific segment.

4. The storage apparatus according to claim 1, wherein the specifying data is sample count information indicating a position of the specific segment.

5. The storage apparatus according to claim 1, wherein the specifying data is information specifying a segment that includes the specific segment as at least part of the segment.

6. The storage apparatus according to claim 1, wherein
the predetermined format is an MP4 file format, and
the one or more programs cause the one or more processors to:
store the specifying data in SampleEntry of the one file; or
store the specifying data as sample group information.

7. The storage apparatus according to claim 1, wherein the one or more programs cause the one or more processors to store audio data of the specific segment, separately from the audio data of the audio, in the one audio file.

8. The storage apparatus according to claim 7, wherein the one or more programs cause the one or more processors to store the audio data of the specific segment in a format different from a format of the audio data of the audio.

9. The storage apparatus according to claim 8, wherein the one or more programs cause the one or more processors to store the audio data of the specific segment, wherein a coding format, a sampling rate, or quantization bit number is, different between the audio data of the specific segment and the audio data of the audio.

10. The storage apparatus according to claim 7, wherein
the predetermined format is an MP4 file format, and
the one or more programs cause the one or more processors to store the audio data of the specific segment in a track different from a track of the audio data, and store the specifying data as track reference information.

11. The storage apparatus according to claim 1, wherein the specifying data further includes characteristic information representing characteristic of the specific segment.

12. The storage apparatus according to claim 11, wherein the characteristic information is either sound pressure information of the specific segment or information indicating that the specific segment is a characteristic part of the audio.

13. A storage apparatus comprising one or more processors and one or more memories storing one or more programs which cause the one or more processors to:
obtain specifying data related to a specific segment, wherein the specifying data includes position information and characteristic information, wherein the position information indicates a position of the specific segment that is a part of audio, and wherein the characteristic information represents characteristic of the specific segment; and
store the specifying data together with the audio data of the audio in one file in a predetermined format.

14. A playback apparatus comprising one or more processors and one or more memories storing one or more programs which cause the one or more processors to:
obtain an audio file including audio data of audio and metadata related to a specific segment that is a part of the audio;
specify audio data of the specific segment by analyzing the metadata; and
read out the audio data of the specific segment, being specified, from the audio file for playback.

15. The playback apparatus according to claim 14, wherein the one or more programs cause the one or more processors to control whether to display an item relating to playback of the audio of the specific segment in a user interface, in accordance with whether the audio file includes the metadata related to the specific segment.

16. A non-transitory computer-readable medium, the medium comprising:
a data structure in which audio data of audio and specifying data related to a specific segment are stored in a predetermined format, wherein the specifying data includes position information and characteristic information, wherein the position information indicates a position of the specific segment that is a part of the audio, and wherein the characteristic information represents characteristic of the specific segment,
wherein the specifying data is used by a playback apparatus in a process of reading out audio data of the specific segment from the audio data of the audio stored in a storage, for playing back the specific segment.

17. A storage method comprising:
detecting a sound pressure of an audio and a repetitive segment in the audio;
generating specifying data for specifying audio data of a specific segment among the repetitive segments being detected, wherein the specific segment is selected in accordance with a sound pressure; and
storing the specifying data together with audio data of the audio in one file in a predetermined format.

18. A storage method comprising:
obtaining specifying data related to a specific segment, wherein the specifying data includes position information and characteristic information, wherein the position information indicates a position of the specific segment that is a part of audio, and wherein the characteristic information represents characteristic of the specific segment; and
storing the specifying data together with the audio data of the audio in one file in a predetermined format.

19. A playback method comprising:
obtaining an audio file including audio data of audio and metadata related to a specific segment that is a part of the audio;
specifying audio data of the specific segment by analyzing the metadata; and
reading out the audio data of the specific segment, being specified, from the audio file for playback.

20. A non-transitory computer-readable medium storing one or more programs which, when executed by a computer comprising one or more processors and one or more memories, cause the computer to:
detect a sound pressure of an audio and a repetitive segment in the audio;
generate specifying data for specifying audio data of a specific segment among the repetitive segments being detected, wherein the specific segment is selected in accordance with a sound pressure; and
store the specifying data together with audio data of the audio in one file in a predetermined format.
